(19) United States
(12) Patent Application Publication
(10) Pub. No.: US 2012/0285770 A1
(43) Pub. Date: Nov. 15, 2012

(54) FALL ARREST APPARATUS

(75) Inventors: Oliver AUSTON, Ashford (GB); Duncan BARRIER, Faversham (GB)

(73) Assignee: Checkmate Limited, Sheerness (GB)

(21) Appl. No.: 13/468,228

(22) Filed: May 10, 2012

(30) Foreign Application Priority Data
May 10, 2011 (GB) 1107743.5

(51) Int. Cl. A62B 35/04; B23P 11/00

(52) U.S. Cl. 182/5; 29/434

(57) ABSTRACT

A fall arrest apparatus comprising a brake assembly (comprising a main body and a clamping mechanism) and a lifeline comprising an elongate first lifeline member and an elongate second lifeline member, the lifeline members overlapping with each other along a section of the lifeline. The main body has a passage extending therethrough, the overlapping section of the lifeline extending through the passage. The configuration is such as to provide from opposite sides of the passage a clamping force to compress together opposed surfaces of the two overlapping lifeline members to prevent these from moving with respect to each other until pulled in relatively opposite directions by a fall of the worker, causing the compressed overlapping members to slidingly contact each other so that energy of the fall is dissipated by sliding friction between said opposed surfaces. The main body has first and second portions on opposite sides of the passage.

### BACKGROUND

a. Field of the Invention

This invention relates to a fall arrest apparatus for use by a worker working at a height above the ground.

b. Related Art

While a worker is working at height, he will typically be connected to a secure mounting by means of a lifeline attached to a harness. Usually the lifeline is wound around a drum. In the event of a fall by the worker, fall arrest devices conventionally work by switching in a friction brake which slows down the rate at which the lifeline is unwound from the drum, while absorbing energy in doing so.

One prior art fall arrest device is disclosed in US patent document 2005/0269153. This discloses a fall arrest device comprising a section of lifeline formed from two lengths of line sewn together. If a worker falls, the fall is broken by the ripping apart of these two lengths, which helps to dissipate energy.

One problem with this device however, is that If the fall is severe enough, the full length of the sewn sections will be torn apart. For this reason, the prior art device also includes a fixed length lifeline in parallel with the torn sections and having a length longer than that of the sewn sections when torn apart. A problem remains, however, because the energy absorbing function ceases as the two sewn sections become fully separated. The document therefore proposes the inclusion of an additional third section of lifeline in the form of an elastic section which is fixed in parallel to the main lifeline. These multiple sections of lifeline create a complex and bulky fall arrest device.

It is therefore an object of the present invention to provide a fall arrest device that is compact and able to controllably arrest the fall of a worker secured to a lifeline.

### SUMMARY OF THE INVENTION

According to the present invention, there is provided a fall arrest apparatus for protecting a worker working at height, comprising a brake assembly and a lifeline for tethering said worker, the lifeline comprising an elongate first lifeline member and an elongate second lifeline member, the first lifeline member extending along a first section of the lifeline and the second lifeline member extending along a second section of the lifeline, said first and second sections overlapping with each other along a third section of the lifeline, and the brake assembly comprising a main body and a clamping mechanism, the main body having a passage extending through the main body, the third section of the lifeline extending through the passage and the configuration of the main body and clamping mechanism being such as to provide from opposite sides of the passage a clamping force to compress together opposed surfaces of said first and second lifeline members in said third section to prevent said first and second lifeline members from moving with respect to each other until said members are pulled in relatively opposite directions by a fall of said tethered worker, causing said first and second lifeline members to move in sliding contact with each other under the compression of the brake assembly so that energy of the fall is dissipated by sliding friction between said opposed surfaces, wherein:
the main body has on opposite sides of the passage a first portion and a second portion, said first portion providing inside the passage a static first clamping surface configured to bear against the first lifeline member; and
the clamping mechanism comprises a pressure plate, the pressure plate providing a second clamping surface inside the passage configured to bear against the second lifeline member to provide said compression of said first and second lifeline members, the pressure plate being dimensioned such that the pressure plate engages with said second portion of the main body and with the pressure plate being retained in the passage at least in part by the presence of the third section of the lifeline extending through the passage.

In other words, whether or not other retention means are used to retain the pressure plate to the main body, the pressure plate has dimensions such that this can only be removed from the passage after at least one, and most preferably both of the lifeline members have been removed from the passage. Removal of the third section of lifeline from the passage is therefore a necessary precondition for removal of the pressure plate from the passage.

In some embodiments, the sliding friction may further comprise friction between the second lifeline member and the second clamping surface.

In a preferred embodiment of the invention, the main body is a unitary main body, that is, of one piece construction, such that first and second portions of the main body are formed from a single piece of material.

Preferably the brake assembly, and in particular the unitary main body, completely surrounds the first and second lifeline members in the third section. Preferably the unitary main body is torus-like.

In a preferred embodiment the first clamping surface is a first side wall of the passage and at least a part of the pressure plate, forming the second clamping surface, is located adjacent to a second opposing side wall of the passage.

Preferably, the brake assembly comprises means for applying an adjustable force to the plate member so as to clamp the first and second lifeline members securely between the clamping surfaces.

Typically the means for applying an adjustable force to the pressure plate comprises a screw, the screw extending through the second portion of the main body and a first end of the screw being in contact with the pressure plate. To prevent the lifeline catching or rubbing on the screw, a second end of the screw preferably does not protrude from an outer surface of the main body.

In a preferred embodiment the pressure plate is U-shaped and comprises a central region that extends through the passage forming the second clamping surface and two arm portions, one at either end of the central region, that extend over a part of the outer surface of the second portion of the main body. Preferably one arm portion is shorter than the other arm portion and the shorter arm portion is dimensioned to pass through the passage in the main body when there are no lifelines in the passage.

Preferably the clamping mechanism further comprises limiting means for limiting the movement of the pressure plate within the passage of the main body to prevent the pressure plate being removed from the passage even if the lifeline members are removed. Preferably the limiting means comprises a slot formed in one arm portion, typically a longer one of the two arm portions, and a pin extending from a part of the outer surface of the main body and through the slot.

An end of the first lifeline member may be looped around the first portion of the main body of the brake assembly in order to secure the second lifeline member to the brake assembly. In this way, the brake assembly is located at a first end of the third section of the lifeline, and in use, in the event of a fall, the brake assembly moves from this first end to a second end of the third section of lifeline. During this movement of the brake assembly, the sliding friction between the two lifeline members dissipates the energy of the fall.

Preferably, the first and second lifeline members are flexible straps, and typically these will be made of webbing.

To prevent the end of the first strap flapping around and becoming caught or trapped while the worker is working, preferably the straps are sewn together with at least one stitch, or other joining means, in the third section of the lifeline. In the event of a fall, the at least one stitch is designed to break, allowing the first and second straps to slide relative to each other. The use of joining means in this way means that, when the first and second lifeline members are under tension, they are typically in touching contact with each other along the full length of the third section of the lifeline.

Also according to the invention there is provided a method of assembling a fall arrest apparatus for protecting a worker working at height, the fall arrest apparatus comprising a brake assembly and a lifeline for tethering said worker, the lifeline comprising first and second lifeline members, and the method comprising the steps of:
forming a main body of the brake assembly, the main body including a passage extending through the main body for receiving the first and second lifeline members, a first portion of the main body being on a first side of the passage and comprising a first side wall of the passage forming a first clamping surface, and a second portion of the main body being on a second opposing side of the passage;
inserting a pressure plate into the passage, the pressure plate being dimensioned such that the pressure plate engages with the second portion of the main body and cannot be removed from the passage once the lifeline members are positioned within the passage, the pressure plate forming a second clamping surface;
inserting an end of the first lifeline member through the passage so that a part of the first lifeline member bears directly against the first side wall of the passage;
inserting an end of the second lifeline member through the passage, between the first lifeline member and the pressure plate; and
applying a force to the pressure plate to clamp together the first and second lifeline members in contact with each other between the first and second clamping surfaces within the passage.

The main body is most preferably formed as a unitary main body.

In a preferred embodiment the pressure plate is U-shaped and comprises a central region and two arm portions, one at each end of the central region, and the method comprises the steps of:
inserting the pressure plate into the passage so that the central region extends through the passage; and
engaging the pressure plate with the second portion of the main body such that the two arm portions extend over a part of the outer surface of the main body.

To reduce the number of parts in the brake assembly and to ease assembly of the fall arrest apparatus, a first one of the two arm portions is preferably dimensioned to pass through the passage and a second one of the two arm portions is preferably dimensioned not to pass through the passage. Additionally the brake assembly comprises limiting means for limiting the movement of the pressure plate within the passage of the main body, and the method of assembly of the brake assembly comprises the steps of:
inserting the pressure plate into the passage, from a first end of the brake assembly, so that the first arm portion passes through the passage and extends over a part of the outer surface of the main body at a second end of the brake assembly; and
engaging the second arm portion with the limiting means such that the pressure plate cannot be withdrawn from the passage.

In embodiments in which the brake assembly includes limiting means, the method preferably comprises the steps of:
forming an elongate slot in the second arm portion of the pressure plate;
forming a hole in an outer surface of the second portion of the main body at the first end of the brake assembly, the hole being dimensioned to receive an end of a pin; and
once the pressure plate has been inserted into the passage, aligning the slot with the hole and inserting the end of the pin into the hole so that the pin extends through the slot, thereby forming the limiting means.

In a preferred embodiment the method further comprises the step of forming a loop around the first portion of the main body with the first end of the first lifeline member to secure the lifeline member to the brake assembly.

Preferably, once the second lifeline member has been inserted through the passage, the method comprises the step of providing means at the first end of the second lifeline member to prevent the second lifeline member being withdrawn from the brake assembly. Typically the end of the second lifeline member will be folded and secured to create a length of double thickness lifeline at the end of the second lifeline member.

### BRIEF DESCRIPTION OF THE DRAWINGS

The invention will now be further described, by way of example only, with reference to the accompanying drawings, in which:

FIG. 1 is a cross-sectional view of a fall arrest apparatus in accordance with a preferred embodiment of the invention, including a brake assembly and lifeline, and showing a pressure plate engaged with the lifeline;

FIG. 2 shows the fall arrest assembly in an initial configuration, with ends of first and second lifeline members secured together and the brake assembly engaged with the lifeline; and

FIG. 3 shows the fall arrest assembly under load during a fall of a worker, with the lifeline members separated.

### DETAILED DESCRIPTION

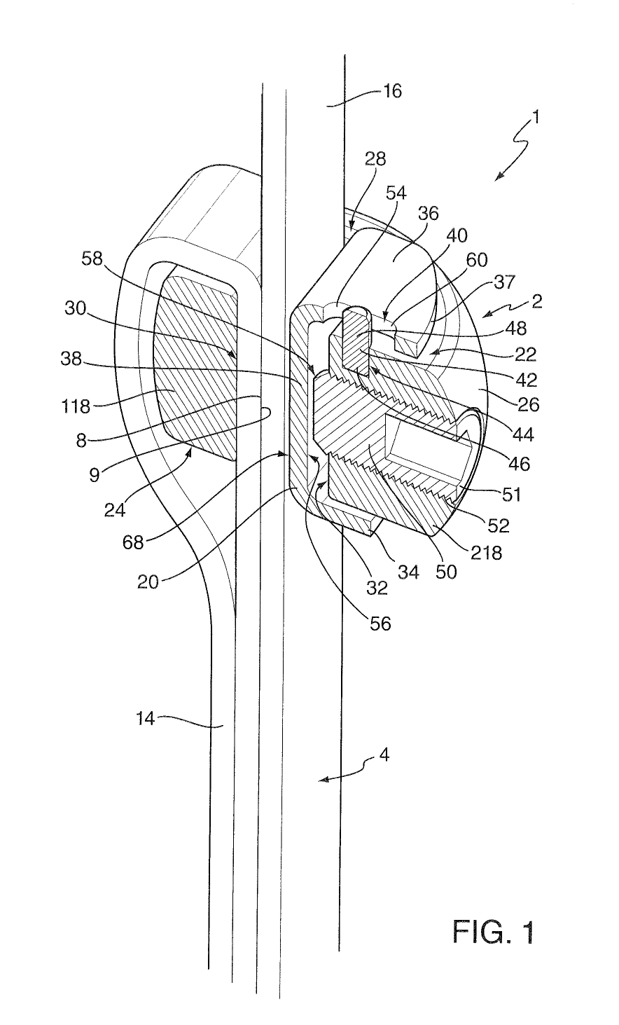

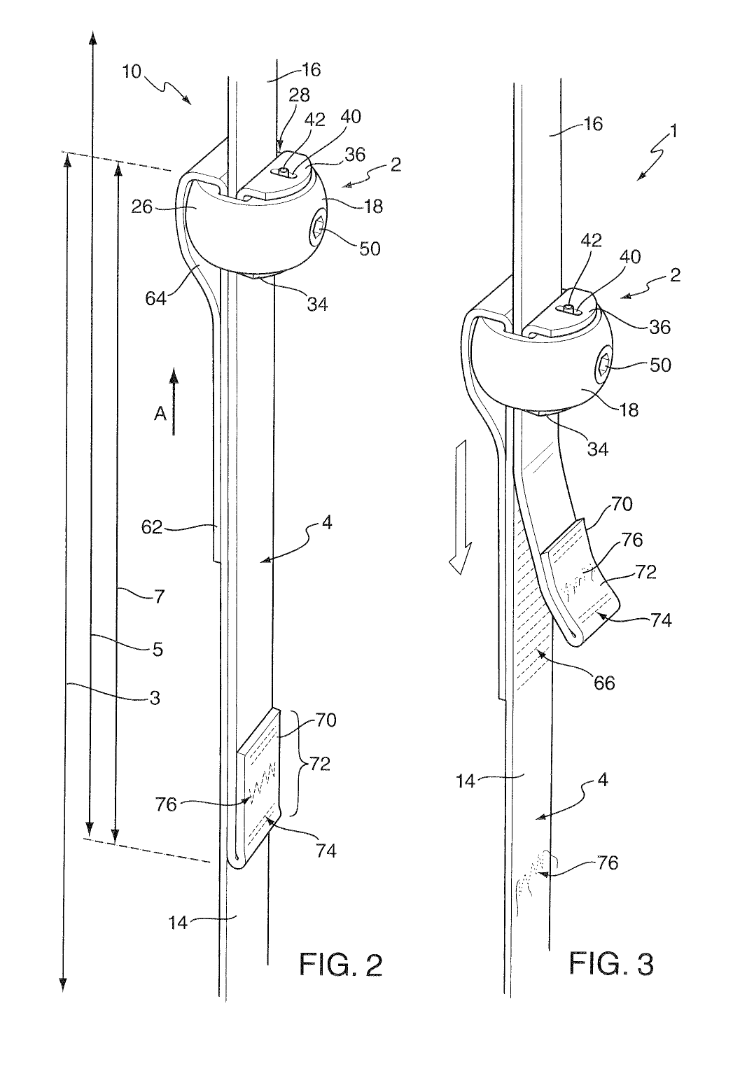

FIGS. 1 to 3 show a fall arrest apparatus 1 including a brake or clamp assembly 2 and a lifeline 4, the lifeline comprising first and second elongate lifeline members 14, 16. As shown schematically in FIG. 2, the first and second lifeline members 14, 16 extend along respective first and second sections of the lifeline 3, 5. The first and second sections 3, 5 of lifeline overlap in a third section 7 of the lifeline 4 such that opposed inner surfaces 8, 9 of the lifeline members are in contact with each other. The brake assembly 2 is located around the third section 7 of the lifeline, where the lifeline passes through a passage 28 that extends fully through the brake assembly 2. In this third section 7 of the lifeline, the first and second lifeline members 14, 16 overlap. The brake assembly 2 is arranged to grip and clamp together the first and second lifeline members 14, 16 inside the passage such that the two lifeline members 14, 16 are in contact with each other and cannot move relative to each other.

Typically the elongate lifeline members 14, 16 will be flexible straps made of webbing or other suitable woven material. In other embodiments, the lifeline members 14, 16 may be made of any suitable strong material, as is well known in the art.

In use, when a worker is working at height, either the first or second lifeline member or strap 14, 16 will be connected at a first end (not shown) remote from the brake assembly 2 to a secure fixed point on the building or other work area. The other lifeline member or strap is secured at a second end (not shown) remote from the brake assembly 2 to the worker's safety harness.

If the worker falls from the area in which he is working, the fall arrest apparatus 1 works like a friction brake. The increased load applied to the end of the second strap 16 due to the fall causes the two lifeline members to slide relative to each other and through the brake assembly 2. The brake assembly 2 is designed to apply a compressive force to the straps 14, 16 so that as the straps slip through the brake assembly 2 sliding friction between the straps dissipates the energy of the fall and slows the descent of the worker.

The advantages of this invention over existing fall arrest devices are its small size and small number of parts, meaning that the device is simple to manufacture and assemble and is lightweight compared to current devices.

As shown in FIG. 1, the brake assembly 2 comprises a unitary main body 18 and a clamping mechanism comprising a pressure plate 20 and a grub screw 50. The unitary main body 18 has on opposite sides of the passage 28 a first portion 118 and a second portion 218. The main body 18 has rounded outer surfaces and has in both the first and second portions a substantially circular cross-sectional shape in planes parallel to the width of the lifeline straps. In this example the length of main body 18 in a direction parallel with the length of the lifeline straps is less than its diameter such that the main body 18 is disc-shaped in a plane perpendicular to the length of the lifeline straps, having flat first and second outer faces 22, 24 of approximately circular periphery at front and rear sides of the main body 18. The circumferential outer surface 26 of the second portion 218 of the main body 18 is curved, having a substantially convex profile. In other embodiments the outer surface 26 of the second portion 218 of the main body 18 may have a different profile, however, it is preferred if the outer surface 26 has a convex curvature as this reduces the likelihood of wear of the straps 14, 16 as they pass over this surface 26.

The passage 28 formed in the main body 18 extends fully through the main body 18 from the first face 22 to the second face 24 so that the main body 18 has a torus-like shape. The passage 28 has a rectangular cross-sectional shape having between the first and second portions 118, 218, first and second opposing end walls, and on the first and second portions 118, 218, respectively, first and second opposing side walls 30, 32. The passage 28 is positioned centrally within the main body 18 so that, in this example, the unitary main body 18 extends completely around the passage 28, and the end walls and side walls 30, 32 extend perpendicular to the faces 22, 24 of the main body 18. The width of the passage 28 extends for almost the full diameter of the main body 18 such that narrow portions of the main body 18 extend around the ends of the passage 28.

A central region 38 of a pressure plate 20 is arranged to locate within the passage 28. The pressure plate 20 includes first and second arm portions 34, 36 that extend perpendicularly from either end of the central region 38 of the pressure plate 20, such that the pressure plate 20 has a U-shaped cross-section. The dimensions of the pressure plate 20 are such that when the pressure plate 20 is located in the passage 28, the central region 38 spans the full length or thickness of the main body 18 and the arm portions 34, 36 extend away from the passage 28 and over respective first and second faces 22, 24 of the main body 18. In this way, when the pressure plate 20 is located in the passage 28, the central region 38 is positioned parallel to and proximate and adjacent one of the side walls 32 of the passage 28.

In a preferred embodiment, the first and second arm portions 34, 36 are of different lengths, the first arm portion 34 being shorter than the second arm portion 36. As shown in FIG. 1, the first arm portion 34 extends only about halfway across the second face 24 of the main body 18. The second arm portion 36 extends almost to the circumferential edge of the main body 18, and the end 37 of the second arm portion 36 is curved so as to follow the shape of this edge. Both the first and second arm portions 34, 36 are in sliding engagement with the respective first and second outer faces 22, 24 of the main body 18.

The first arm portion 34 is short enough in a direction perpendicular to the plane of the lifeline straps, so that, with no lifeline inside the passage 28, the first arm portion can be inserted into the passage to assemble the pressure plate with the main body 18. Conversely, when at least one of the lifeline straps is subsequently inserted into the passage, the first arm portion 34 is long enough in a direction perpendicular to the plane of the lifeline straps, such that the lifeline straps prevent the first arm portion 34 from disengaging with the second outer face 24 of the main body 18, even in the absence of other retaining means, such as a retaining pin 42 described below. The pressure plate 20 is therefore dimensioned such that the pressure plate engages with the second portion 218 of the main body with the pressure plate being retained in this engagement within the passage at least in part by the presence of the third section 7 of the lifeline extending through the passage 28. Conversely, the pressure plate cannot be removed from the passage, even with the retaining pin removed, as long as at least one of the lifelines is present inside the passage. This provides security for the braking mechanism, so that even if the grub screw 50 is fully loosened so that this no longer bears on the pressure plate, the pressure plate cannot come loose from the main body. Additionally, when the main body is a unitary main body, it is impossible for the main body to come apart, for example into separately joined components, which ensures that the fall arrest apparatus cannot become dysfunctional owing to components of the main body becoming loose.

A through slot 40 in the second arm portion 36 of the pressure plate 20 receives a retaining pin 42, as will be described in more detail below. The longitudinal axis of the slot 40 is perpendicular to the plane of the central region 38, such that the slot 40 extends along the length of the arm portion 36 from close to the end of the central region 38 of the pressure plate 20 to proximate the curved end 37 of the arm portion 36.

The retaining pin 42 sits within a hole 44 formed in the first face 22 of the main body 18. The hole 44 and pin 42 are sized so that a first end 46 of the pin 42 fits tightly within the hole 44. A second end 48 of the pin 42 protrudes from the first face 22 of the main body 18 and, when the pressure plate 20 is located within the passage 28, the pin 42 extends into the slot 40. In this way, the pin 42 and slot 40 form limiting means to limit the movement of the pressure plate 20 within the passage 28 as explained further below.

The grub screw 50 of the clamping mechanism fits within a threaded bore 52 formed through the main body 18. The bore 52 extends from the curved circumferential surface 26 of the main body 18 to one of the side walls 32 of the passage 28. In this way, when the grub screw 50 is inserted into the bore 52, an end 58 of the screw 50 is able to extend into the passage 28 and engage with the pressure plate 20. Preferably an Allen key or Hex key is used to secure the grub screw 50 within the bore 52. It is advantageous if the screw 50 does not have an end or head 51 that protrudes from the surface 26 of the main body 18, when the screw 50 is fully inserted in the bore 52, so that the lifeline 4 does not rub on the edges of the screw head in use. Preferably the end 51 of the screw 50 is substantially flush, or slightly recessed, with the outer surface 26 of the main body 18 when the screw 50 is fully inserted in the bore 52.

To assemble the brake assembly 2, the pressure plate 20 is inserted through the passage 28. The shorter length of the first arm portion 34 of the pressure plate 20 allows this end of the pressure plate 20 to be passed through the passage 28. Once the pressure plate 20 is in position in the passage 28, the retaining pin 42 is pushed through the slot 40 until the first end 46 of the pin 42 locates fully in the hole 44 in the main body 18. Once the pin 42 is in place, the pressure plate 20 cannot be removed from the passage 28 without first removing the pin 42.

With the retaining pin 42 at a first end 54 of the slot 40 nearest the central region 38, a rear face 56 of the central region 38 of the pressure plate 20 is in contact with the side wall 32 of the passage 28. In this way, the side wall 30 of the passage 28 and a front face 68 of the pressure plate 20 form opposing clamping surfaces. The static side wall 30 and movable front face 68 of the pressure plate 20 will therefore be referred to below as, respectively, first and second clamping surfaces 30, 68. The static first clamping surface 30 is configured to bear against the first lifeline member 14 and the movable second clamping surface 68 is configured to bear against the second lifeline member 16.

The grub screw 50 is screwed into the bore 52 in the main body 18, and as the grub screw 50 is inserted further into the bore 52, the end 58 of the grub screw 50 makes contact with the rear face 56 of the pressure plate 20. As the grub screw 50 is tightened, the end 58 pushes against the rear face 56 of the pressure plate 20 and forces the central region 38 of the pressure plate 20 away from the side wall 32 of the passage 28. In this way, the grub screw 50 provides means for applying an adjustable force to the pressure plate 2 to clamp the lifeline members 14, 16 as explained below. As the pressure plate 20 moves away from the side wall 32, the retaining pin 42 moves towards a second end 60 of the slot 40, and movement of the pressure plate 20 is limited by the length of the slot 40. Because the movement of the second end 48 of the retaining pin 42 is confined by the bounds of the slot 40, the pressure plate 20 is guided to move smoothly towards the centre of the passage 28 with the central region 38 of the pressure plate 20 remaining substantially parallel to the side wall 32.

Preferably, the brake assembly 2 including the main body 18 and the clamping mechanism is made from a non-corrosive metal, for example stainless steel.

To fit the straps 14, 16 into the brake assembly 2, the pressure plate 20 is initially located so that the central region 38 of the pressure plate 20 sits against the side wall 32 of the passage 28.

A first end 62 of the first strap 14 is passed through the passage 28 in a first direction, indicated by arrow A in FIG. 2. The end 62 of the first strap 14 is then wrapped around the main body 18 of the clamp assembly 2 so that a part of the strap 14 covers the first clamping surface 30 of the passage 28, a part of the first face 22 of the main body 18 adjacent to the first clamping surface 30 and a part of the convex outer surface 26 of the main body 18. In this way, the first and 62 of the first strap 14 doubles back on itself and a loop 64 is formed around one half of the brake assembly 2.

The end 62 of the first strap 14 is sewn securely to itself as indicated by the series of straight dashed lines 66 in FIG. 3. The end portion 62 may be securely fastened using other means, but any fastening means should be sufficient to prevent the end 62 of the first strap 14 coming apart when an increased load is applied during a fall. In this way, the first strap 14 remains securely attached to the brake assembly 2 at all times.

The second strap 16 is then passed through the passage 28 in the brake assembly 2 in the opposite direction to the first strap 14. This second strap 16 is, therefore, positioned between a portion of the first strap 14 and the second clamping surface 68 (see FIG. 1) of the pressure plate 20.

An end 70 of this second strap 16 is folded back on itself to form a double-thickness end portion 72. This end portion 72 is securely sewn together, or fastened together using any other suitable means, such that this end portion 72 will not separate even when an increased load is applied to the lifeline 4 during a fall. This secure fastening is indicated by the straight dashed lines 74 in FIGS. 2 and 3.

The end region 72 of the second strap 16 is then loosely attached to a point on the first strap 14 at a distance from the brake assembly 2 so that the first and second straps 14, 16 overlap along their length between the brake assembly 2 and the end 70 of the second strap 16. In this example, the two straps 14, 16 are sewn together as indicated by the zigzag stitches 76 in FIGS. 2 and 3. These stitches 76 pass through the double thickness end portion 72 of the second strap 16 and through the first strap 14. In other embodiments, the two straps 14, 16 may be joined together using other means, however, the joining means must be such that the two straps 14, 16 separate easily when a load is applied to the lifeline in the event of a fall. With the straps 14, 16 arranged in this way, when the straps are under tension, for example at the start of a fall, the two straps 14, 16 are in touching contact with each other along the full length of the third section 7 of lifeline where the straps 14, 16 overlap.

Once the two straps 14, 16 are in place in the passage 28 of the main body 18, the grub screw 50 is tightened. The end 58 of the grub screw 50 pushes against the rear face 56 of the pressure plate 20 and presses the second clamping surface 68 of the pressure plate 20 against the second strap 16. As the grub screw 50 is tightened further, a compressive force is applied and the two straps 14, 16 are clamped together in contact with each other within the passage 28.

In the event of a worker falling from a height, when an increased load is applied to the lifeline, the temporary stitches 76 joining the two straps 14, 16 break, as shown in FIG. 3. The two straps 14, 16 are then free to move with respect to each other. The brake assembly 2 slides along the second strap 16 towards the double thickness end region 72, as indicated by the arrow in FIG. 3.

Because the two straps 14, 16 are held tightly within the brake assembly 2, there is a large frictional force generated between the two straps as the second strap 16 is pulled through the passage 28 of the brake assembly 2. This sliding friction dissipates the energy of the fall and, therefore, acts to slow the descent of the worker. When the brake assembly 2 reaches the end region 72 of the second strap 16, the increased thickness of the end region 72 means that the end 70 is unable to pass through the passage 28, and the worker's fall is stopped. Preferably, a sufficient length of the second strap 16 has passed through the brake assembly 2 that the sliding friction has slowed the rate of falling such that little additional deceleration occurs when the brake assembly 2 reaches the end region 72 of the second strap 16.

Generally, the majority of the sliding friction will be generated between the two straps 14, 16, however, in some embodiments it may be preferable if a significant frictional force is also generate between the straps 14, 16 and the second clamping surface 68 of the brake assembly 2. This may be achieved by roughening the second clamping surface 68.

The amount of frictional force may be adjusted and controlled simply by varying the compressive force that is applied to the straps 14, 16 by the pressure plate 20, which is in turn adjusted by tightening or loosening the grub screw 50 as required.

The fall arrest apparatus 10 of the present invention, therefore, provides a compact and lightweight device, having relatively few components, that controllably dissipates the energy of a fall.

It is to be recognized that various alterations, modifications, and/or additions may be introduced into the constructions and arrangements of parts described above without departing from the spirit or scope of the present invention, as defined by the appended claims.

1. A fall arrest apparatus for protecting a worker working at height, comprising a brake assembly and a lifeline for tethering said worker, the lifeline comprising an elongate first lifeline member and an elongate second lifeline member, the first lifeline member extending along a first section of the lifeline and the second lifeline member extending along a second section of the lifeline, said first and second sections overlapping with each other along a third section of the lifeline, and the brake assembly comprising a main body and a clamping mechanism, the main body having a passage extending through the main body, the third section of the lifeline extending through the passage and the configuration of the main body and clamping mechanism being such as to provide from opposite sides of the passage a clamping force to compress together opposed surfaces of said first and second lifeline members in said third section to prevent said first and second lifeline members from moving with respect to each other until said members are pulled in relatively opposite directions by a fall of said tethered worker, causing said first and second lifeline members to move in sliding contact with each other under the compression of the brake assembly so that energy of the fall is dissipated by sliding friction between said opposed surfaces, wherein:
the main body has on opposite sides of the passage a first portion and a second portion, said first portion providing inside the passage a static first clamping surface configured to bear against the first lifeline member; and
the clamping mechanism comprises a pressure plate, the pressure plate providing a second clamping surface inside the passage configured to bear against the second lifeline member to provide said compression of said first and second lifeline members, the pressure plate being dimensioned such that the pressure plate engages with said second portion of the main body and with the pressure plate being retained in the passage at least in part by the presence of the third section of the lifeline extending through the passage.

2. A fall arrest apparatus as claimed in claim 1, in which said sliding friction further comprises friction between the second lifeline member and the second clamping surface.

3. A fall arrest apparatus as claimed in claim 1, in which the main body is a unitary main body.

4. A fall arrest apparatus as claimed in claim 3, in which the main body completely surrounds the first and second lifeline members in said third section.

5. A fall arrest apparatus as claimed in claim 3, in which the unitary main body is torus-like.

6. A fall arrest apparatus as claimed in claim 1, in which the first clamping surface is a first side wall of the passage and at least a part of the pressure plate, forming the second clamping surface, is located adjacent to a second opposing side wall of the passage.

7. A fall arrest apparatus as claimed in claim 1, in which the clamping mechanism comprises additionally a means for applying an adjustable force to the pressure plate, said means comprising a screw, the screw extending through the second portion of the main body and a first end of the screw being in contact with the pressure plate.

8. A fall arrest apparatus as claimed in claim 7, in which a second end of the screw does not protrude from an outer surface of the main body.

9. A fall arrest apparatus as claimed in claim 1, in which the pressure plate is U-shaped and comprises a central region that extends through the passage forming the second clamping surface and two arm portions, one at either end of the central region, that extend over a part of the outer surface of the second portion of the main body.

10. A fall arrest apparatus as claimed in claim 9, in which the clamping mechanism further comprises limiting means for limiting the movement of the pressure plate within the passage of the main body, the limiting means comprising a slot formed in one arm portion and a pin extending from said part of the outer surface of the main body and through said slot.

11. A fall arrest apparatus as claimed in claim 1, in which an end of the first lifeline member is looped around the first portion of the main body.

12. A fall arrest apparatus as claimed in claim 1, in which the third section of the lifeline extends between opposite first and second ends of said third section, the brake assembly being located at the first end of the third section of the lifeline, and wherein, in use, in the event of a fall, the brake assembly moves from said first end to the second end of the third section of the lifeline.

13. A fall arrest apparatus as claimed in claim 1, in which said first and second lifeline members, when under tension, are in touching contact with each other along the full length of the third section of the lifeline.

14. A method of assembling a fall arrest apparatus for protecting a worker working at height, the fall arrest apparatus comprising a brake assembly and a lifeline for tethering said worker, the lifeline comprising first and second lifeline members, and the method comprising the steps of:
forming a main body of the brake assembly, the main body including a passage extending through the main body for receiving the first and second lifeline members, a first portion of the main body being on a first side of the passage and comprising a first side wall of the passage forming a first clamping surface, and a second portion of the main body being on a second opposing side of the passage;
inserting a pressure plate into the passage, the pressure plate being dimensioned such that the pressure plate engages with the second portion of the main body and cannot be removed from the passage once the lifeline members are positioned within the passage, the pressure plate forming a second clamping surface;
inserting an end of the first lifeline member through the passage so that a part of the first lifeline member bears directly against the first side wall of the passage;
inserting an end of the second lifeline member through the passage between the first lifeline member and the pressure plate; and
applying a force to the pressure plate to clamp together the first and second lifeline members in contact with each other between the first and second clamping surfaces within the passage.

15. A method as claimed in claim 14, in which the main body is formed as a unitary main body.

16. A method as claimed in claim 14, in which the pressure plate is U-shaped and comprises a central region and two arm portions, one at each end of the central region, and the method comprises the steps of:
inserting the pressure plate into the passage so that the central region extends through the passage; and
engaging the pressure plate with the second portion of the main body such that the two arm portions extend over a part of the outer surface of the main body.

17. A method as claimed in claim 16, in which a first one of the two arm portions is dimensioned to pass through the passage and a second one of the two arm portions is dimensioned not to pass through the passage, and the brake assembly comprises limiting means for limiting the movement of the pressure plate within the passage of the main body, and wherein the method comprises the steps of:
inserting the pressure plate into the passage, from a first end of the brake assembly, so that said first arm portion passes through the passage and extends over a part of the outer surface of the main body at a second end of the brake assembly; and
engaging said second arm portion with said limiting means such that the pressure plate cannot be withdrawn from the passage.

18. A method as claimed in claim 17, in which the method comprises the steps of:
forming an elongate slot in said second arm portion of the pressure plate;
forming a hole in an outer surface of the second portion of the main body at the first end of the brake assembly, the hole being dimensioned to receive an end of a pin; and
once the pressure plate has been inserted into the passage, aligning the slot with the hole and inserting the end of the pin into the hole so that the pin extends through the slot, thereby forming said limiting means.

19. A method as claimed in claim 14, in which the method further comprises the step of forming a loop around the first portion of the main body with said first end of the first lifeline member.

20. A method as claimed in claim 14, in which, once the second lifeline member has been inserted through the passage, the method comprises the step of providing means at an end of the second lifeline member to prevent the second lifeline member being withdrawn from the brake assembly.
